(19) United States
(12) Patent Application Publication
(10) Pub. No.: US 2025/0084554 A1
(43) Pub. Date: Mar. 13, 2025

(54) METHODS OF RECOVERING METALS FROM WASTE SOURCES

(71) Applicant: UCHICAGO ARGONNE, LLC, Chicago, IL (US)

(72) Inventors: Timothy T. Lichtenstein, Downers Grove, IL (US); Colin E. Moore, Naperville, IL (US)

(21) Appl. No.: 18/367,919

(22) Filed: Sep. 13, 2023

(51) Int. Cl. C25C 7/06; C25C 3/34; C25C 3/36

(52) U.S. Cl. CPC C25C 7/06; C25C 3/34; C25C 3/36

(57) ABSTRACT

Provided herein are methods for extracting and separating metals from a mixture of metal oxides comprising: disposing a cathode comprising the mixture of metal oxides, a reducing electrode, and an anode in a solvent comprising a mixture of molten metal hydroxide salts; applying an electrical potential to a cathode, thereby reducing the mixture of metal oxides and forming a mixture of metals; selectively dissolving one or more metal ion species from the mixture of metals into the dried solvent; and applying a potential to the reducing electrode present in the dried solvent to reduce the dissolved metal ion species from the dried solvent to a respective pure metal or mixed metal.

### STATEMENT OF GOVERNMENT SUPPORT

This invention was made with government support under Contract No. DE-AC02-06CH11357 awarded by the United States Department of Energy to UChicago Argonne, LLC, operator of Argonne National Laboratory. The government has certain rights in the invention.

### FIELD

The disclosure relates generally to methods for extracting and separating metals from mixtures such as waste sources. More particularly, the disclosure relates to methods of using molten metal hydroxide salts and electricity to extract and separate metals from mixtures.

### BACKGROUND

In recent years, the development of electronic products and information technology has increased rapidly. Accompanied by the rapidly increased use of electronic products and devices, the life cycles of these products have become shorter. Components of electronic products, including batteries and magnets, typically include a variety of transition metals and rare earth metals. These metals often have high economic value, or high costs associated with their refinement. This is due to the electronic and mechanical properties of these metals. Therefore, it is desirable to recycle metal components from electronic devices or other waste sources.

Despite efforts to recycle metals from waste sources electrochemically, these processes generate toxic by-products such as Cl_{2(g)} and perfluorocarbon and do not refine the waste source to pure metal or metal mixtures. As a result, traditional pyrometallurgical recovery is expensive and energy intensive to perform. Traditional processes involve temperatures as high as 1000° C. and react metal oxides with carbon, producing large amounts of carbon dioxide during processing. Furthermore, these reduced metals require additional pyrometallurgical processes to purify the recovered mixed metals. Thus, current methods of recycling metals represent an environmental threat.

Robust methods of recycling electronic waste are of great interest as part of a green energy system. However, in order to be of practical value and use, recovery methods need to be efficient and selective. Electrochemical recycling methods can provide selectivity, but often are less efficient. While other recycling methods are more efficient, these recycling methods cannot separate metals with electrochemical specificity.

### SUMMARY

Methods in accordance with the disclosure can be used to recover materials from electronic wastes containing mixed or pure metal oxides such as batteries and magnets as metals (e.g., Li, Ni, Mn, Co, Nd, etc.). These materials can be used for green energy devices and the recovery of these materials from built-up wastes can be part of maintaining a domestic supply chain for green energy devices.

Methods of the disclosure can help decrease the energy requirements of recycling mixed or pure metal oxides from electronic wastes and refining metals from ores, and decrease costs associated with recovering and refining mixed or pure metal oxides.

A method of extracting and separating metals from a mixture of metal oxides in accordance with the disclosure can include: disposing a cathode that can include the mixture of metal oxides, a reducing electrode, and an anode in a solvent that can include a mixture of molten metal hydroxide salts; applying an electrical potential to a cathode, thereby reducing the mixture of metal oxides and forming a mixture of metals; selectively dissolving one or more metal ion species from the mixture of metals into the solvent; and applying a potential to the reducing electrode present in the solvent to reduce the dissolved metal ion species from the solvent to a respective pure metal or mixed metal. The one or more metal ion species from the mixture of metals can be selectively dissolved by increasing or decreasing the electrical potential applied to the cathode. Alternatively, or additionally, the one or more metals can be selectively dissolved when they come in contact with water present in the solvent, which oxidizes and thereby dissolves the one or more metal ion species into the solvent. Selectively dissolving the one or more metal ion species can include controlling a water content of the solvent such that upon contact of the one or more metals with the water of the solvent, selective ones of the one or more metals oxidize and thereby selective ones of the one or more metal ion species are dissolved into the solvent.

### BRIEF DESCRIPTION OF THE DRAWINGS

FIG. 1 is a schematic representation of general reduction and separation of metal components from mixed metal oxides.

FIG. 2 is a photograph of NMC reagent material and recovered metal product.

FIG. 3 is a SEM-EDS micrograph and X-ray element maps of a representative region of the recovered reduced metal Nd product under Ar atmosphere from constant current electrolysis in a hydrated solvent.

FIG. 4 is a SEM-EDS micrograph and X-ray element maps of a representative region of the recovered reduced metal NMC 111 product under Ar atmosphere from constant current electrolysis in a hydrated solvent.

FIG. 5 is a SEM-EDS micrograph and X-ray element maps of a representative region of the recovered reduced metal NMC 622 product under Ar atmosphere from constant current electrolysis in a hydrated solvent.

FIG. 6 is a SEM micrograph of the reduced metal NMC 622 air-prepared product.

FIG. 7 is a SEM micrograph and X-ray elemental maps of electrowinned metal product recovered from the reduced metal NMC 622 air-prepared product.

FIG. 8 is a cyclic voltammogram (CV) of a W wire electrode in the blue salt, containing the NMC 622 air-prepared product.

FIG. 9 is a cyclic voltammogram of a W wire electrode before and after drying the molten hydroxide salt.

FIG. 10 is a SEM micrograph of the recovered metal product after NMC 622 reduction in dry salt.

FIG. 11 is a photograph of cathode after reduction of NMC 622 in dry salt, with adhered salt present.

FIG. 12 is a cyclic voltammogram of a W wire before and after reduction of NMC 622 in dry salt. Solid and dashed vertical lines denote electrical potentials where Ni-Co rich alloys and Ni-Mn rich alloy collected was performed, respectively.

FIG. 13 is a SEM micrograph of a Ni-Mn rich alloy electrowinned from the reduced metal NMC 622 in dry salt.

FIG. 14 is a SEM micrograph of a Ni-Co rich alloy electrowinned from the reduced metal NMC 622 in hydrated salt.

### DETAILED DESCRIPTION

Provided herein are methods for extracting and separating pure or mixed metals from metal oxides.

The methods of the disclosure can reduce and selectively separate pure or mixed metals from metal oxide mixtures by using a molten hydroxide salt solution at temperatures less than 350° C. In accordance with methods of the disclosure, metal oxide mixtures such as lithiated or sodiated transition metal or rare earth oxide mixtures can be used. Selective extraction of metals from mixed metal oxide sources is achieved by applying a voltage to a cathode containing the mixture of metal oxides to convert the mixed metal oxides to a mixed metal; and dissolving specific metal components into the molten salt solution by applying a voltage to another electrode while simultaneously either i) changing the voltage of the cathode or ii) controlling a water content of the solvent such that upon contact of the one or more metals with the water of the solvent, selective ones of the one or more metals oxidize and thereby selective ones of the one or more metal ion species are dissolved into the solvent, to selectively reduce each component to pure metal from the salt.

The methods of the disclosure can further comprise drying the solvent before disposing the cathode, the reducing electrode, and the anode in the solvent. In the methods of the disclosure, drying the solvent can include i) reducing the pressure of the solvent thereby evaporating water present in the solvent, or ii) passing an electrical current through the solvent, thereby electrolyzing water present in the solvent.

### Methods of the Disclosure

A method of extracting and separating metals from a mixture of metal oxides in accordance with the disclosure can include drying a solvent in which one or more metal hydroxide salts are mixed and heated above the melting temperature of the salt thereby providing a solvent comprising the mixture of molten metal hydroxide salts, disposing a cathode, a reducing electrode, and an anode in the solvent, applying an electrical potential to a cathode, selectively dissolving one or more metal ion species from the mixture of metals into the solvent, and applying a potential to the reducing electrode present in the solvent to reduce the dissolved metal ion species from the solvent to a respective pure metal or mixed metal.

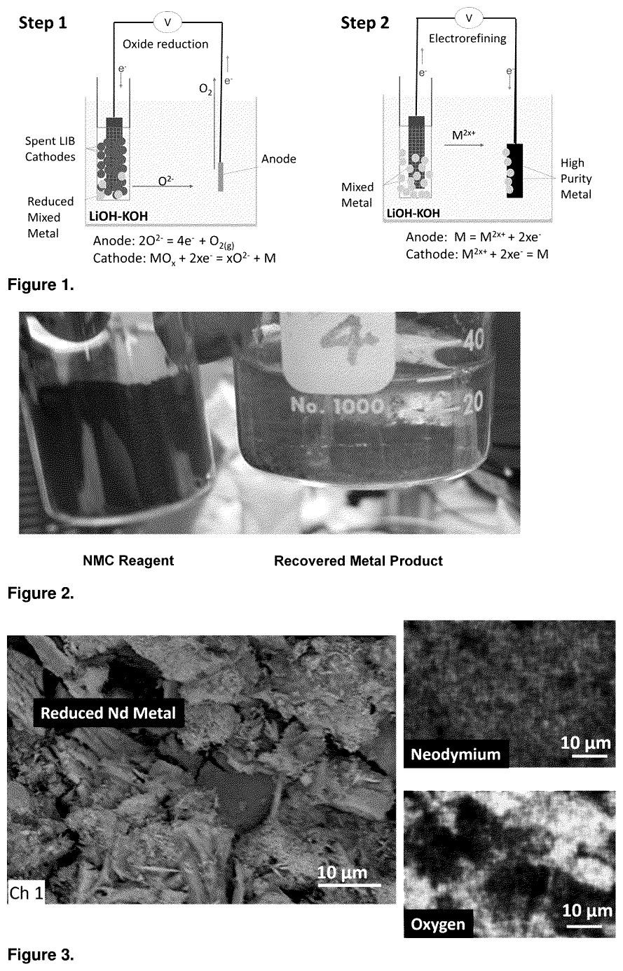

As shown schematically in FIG. 1, an electrical potential can be applied to a cathode of mixed metal oxides in a solvent comprising a molten hydroxide salt mixture to convert the mixed metal oxides into a mixed metal. (Step 1). The metal ion species of the mixed metal from Step 1 can be selectively dissolved from the mixed metal into the solvent by either increasing or decreasing the electrical potential applied to the cathode or reacting the metal components of the mixed metal with water in the solvent, while applying a potential to the reducing electrode present in the solvent to reduce the dissolved metal ion species, thereby providing the respective pure metal or mixed metal. (Step 2)

The molten metal hydroxide salt mixture can be produced by mixing one or more metal hydroxide salts and heating the metal hydroxide salt mixture. The metal hydroxide salts can be hydrated. The metal hydroxide salts can be one or more of alkali metal hydroxide salts, alkaline earth metal hydroxide salts, or transition metal hydroxide salts. For example, the metal hydroxide salts can include one or more alkali metal hydroxide salt selected from LiOH, NaOH, and KOH and/or at least one alkaline earth metal hydroxide salt selected from Mg(OH)₂ and Ca(OH)₂. For example, the solvent is a mixture of LiOH and KOH or NaOH and KOH.

In methods of the disclosure, the solvent can be a eutectic mixture of molten metal hydroxide salts. For example, the solvent is a eutectic mixture of LiOH and KOH or NaOH and KOH. The eutectic mixture melts at a lower temperature than either constituent of the mixture which can lower operating costs, improve safety, and scalability.

In methods of the disclosure, the temperature of the solvent during operation is held constant. The operating temperature can be 150° C. to 1000° C. For example, the temperature of the solvent during operation can be 150° C. to 800° C., 150° C. to 700° C., 150° C. to 600° C., or 150° C. to 500° C.

The reducing electrode and the anode can each independently include steel and/or refractory metals i.e., metals with high melting points and stability. For example, the reducing electrode and anode each independently are one or more element selected from C, Fe, Ni, W, Mo, Ta, Ti, V, Cr, Mn, Zr, and Hf. For example, each of the reducing electrode and anode can be W.

The cathode can include a mixture of metal oxides. The mixture of metal oxides can include any number of different metal oxides such as two or more different metal oxides, three or more different metal oxides, etc. For example, the mixture of metal oxides can be one or more alkali metal oxides, alkaline earth metal oxides, transition metal oxides, and rare earth metal oxides, or the mixture of metal oxides comprises transition metal oxides and alkali metal oxides. For example, the mixture of metal oxides can be lithium nickel manganese cobalt oxides (NMCs).

The cathode can also be a waste source, such as electronic waste. Electronic wastes commonly include mixed or pure metal oxides in components such as batteries, magnets, circuit boards, and wiring. The method of extracting and separating metals from a mixture of metal oxides can be performed with a cathode comprising an electronic waste source to recover pure metals or mixtures of metals that can be recycled in manufacture of new materials.

In methods of the disclosure, the metal or mixed metal provided is substantially pure. When a pure metal is provided, the material is substantially free of any elements other than the specific metal. When a pure mixed metal is provided, the material is substantially free of any elements other than the specified metals. For example, the pure metal or mixed metal has a purity of 50% to 99%, 55% to 99%, 60% to 99%, 65% to 99%, or 70% to 99% (w/w).

### Drying Molten Hydroxide Salt

The methods of extracting and separating metals from a mixture of metal oxides in accordance with the disclosure can further include drying the solvent before disposing the cathode, the reducing electrode, and the anode in the solvent. In methods of the disclosure, the solvent can be dried by reducing the pressure of the solvent, thereby evaporating water present in the solvent, or by passing an electrical current through the solvent, thereby electrolyzing water present in the solvent. The drying procedure can advantageously eliminate the need to prepare salts in an inert atmosphere (e.g., gloveboxes), allowing for the use of lower purity and hydrated salts and possibly reducing the overall operating cost of the process.

Methods of the disclosure can optionally include drying the solvent to a target water content. As a result of drying, the solvent includes the mixture of molten metal hydroxide salts and a water content that is lower, as compared to the solvent prior to drying. In some aspects of the method, the amount of water present in the solvent prior to drying can cause undesirable reactions to occur during the reduction process which decreases the coulombic efficiency and lowers selectivity of the overall process. In molten salt systems, the Lux-Flood definition of acid-base theory is commonly used. This definition describes an acid as an oxide ion (O²) acceptor and a base as an oxide ion donor. During the reduction process, water can be electrolytically reduced and act as a Lux-Flood acid and accept an oxide ion from one or more metal oxides present, and thereby reduce the one or more metal oxides to a metal or mixture of metals. If the water content in the solvent is too large, then the composition of the pure metal or mixture of metals provided will be based on the relative reactivity of the metal oxides, only. If the water content in the solvent is sufficiently low, then the one or more metal oxides can be selectively reduced by controlling the electrical potential. Controlling the water content of the solvent can advantageously allow the composition of the metal or mixture of metals provided to be controlled by selective dissolving of one or more metal ion species into the solvent. For example, the solvent can be dried to a water content below 8, 7, 6, 5, 4, 3, 2, or 1% (w/w). For example, the solvent can be dried to a water content that is greater than 0% (w/w), but less than 8% (w/w).

The solvent can be dried by either reducing the pressure of the solvent, thereby evaporating water present in the solvent, or by passing an electrical current through the solvent, thereby electrolyzing water present in the solvent. For example, reducing the pressure in the can include reducing the pressure to about 2500 Pa or less. The pressure can be reduced, for example, for a time of about 30 minutes to about 720 minutes. For example, passing an electrical current through the solvent can include passing an electrical current of about 0.01 A to about 5 A and/or for a time of about 30 minutes to about 360 minutes.

The solvent can be dried while at a temperature of about 150° C. to about 1000° C., about 300° C. to about 800° C., about 400° C. to about 700° C., about 250° C. to about 600° C., or about 150° C. to about 500° C. For example, the solvent can be dried while at a temperature of 150° C. to 1000° C. It has been found advantageous to perform the drying process at elevated solvent temperatures to ensure that the salt is maintained in the molten state during drying. Selection of the temperature of the solvent during drying can be, for example, a temperature above the melting temperature of the mixture of hydroxide salts.

In methods of the disclosure, drying the solvent by passing an electrical current through the solvent can further include purging the solvent with an inert gas after drying the solvent. For example, the solvent is purged with an inert gas selected from Ar_{(g)}, N_{2(g)}, and He_{(g)}, after drying the solvent.

### Reduction of Metal Oxides to Form Mixtures of Metals

As discussed above, the electrical potential applied to the cathode causes the reduction of the metal ion species of the mixture of metal oxides, thereby forming a mixture of metals. (FIG. 1) The electrical potential applied at the cathode can be any suitable electrical potential. The electrical potential can be selected based on the metals present in the mixture of metal oxides, such that the electrical potential can reduce each of the metals present. For example, the electrical potential applied to the cathode is 0 V to 5 V or 0 V to 3 V.

The electrical potential applied at the cathode can be held constant for any amount of time. For example, the electrical potential applied at the cathode can be held constant for a time of 30 minutes to 360 minutes.

After the electrical potential has been applied, the mixture of metal oxides is substantially a mixture of metals or mixed metal. The amount of metal oxide reduced will be related to the amount of contact between the metal oxide and the cathode. The mixture of metal oxides does not need to be completely reduced in order to selectively dissolve and separate metal ion species present.

### Selective Dissolution and Separation of Metal Ion Species

As discussed above, the metal ion species of the mixed metal can be selectively dissolved from the mixed metal into the solvent while applying an electrical potential to the reducing electrode present in the solvent to reduce the dissolved metal ion species, thereby providing the respective pure metal or mixed metal (FIG. 1).

In methods of the disclosure, selectively dissolving one or more metal ion species from the mixture of metals can include increasing or decreasing the electrical potential applied to the cathode. Alternatively, or additionally, selectively dissolving the one or more metal ions can be accomplished when the one or more metals come into contact with water in the solvent. Controlling the water content of the solvent can be used for selection of the one or more metal ion species to be dissolved. In general, selectively dissolving one or more metal ion species from the mixture of metals can include selectively oxidizing the mixture of metals to form one or more metal ion species while not oxidizing other metals present in the mixture.

For example, selectively dissolving one or more metal ion species from the mixture of metals can include increasing or decreasing the electrical potential applied to the cathode. As the electrical potential applied to the cathode is changed, some metal ion species can be selectively oxidized based on the reduction potential of the metal ion. These oxidized metal ion species can dissolve in the solvent.

The electrical potential can be increased or decreased from an initial electrical potential applied to the cathode, based on the metal ion species present. In general, increasing the electrical potential applied to the cathode provides metals and mixtures of metals that have higher reduction potentials than the initial electrical potential, while decreasing the electrical potential applied to the cathode provides metals and mixtures of metals that have lower reduction potentials than the initial electrical potential. The magnitude of the change in electrical potential can be selected based on the metal ion species. In general, larger changes in electrical potential applied to the cathode provide mixtures of metals, while smaller changes in electrical potential can allow for separation of the individual metal ion species. For example, the electrical potential applied to the cathode is increased or decreased by 0.005 V/s to 5 V/s, 0.005 V/s to 3V/s, 0.005 V/s to 1 V/s, 0.005 V/s to 0.5 V/s, or 0.005 V/s to 0.100 V/s.

For example, selectively dissolving one or more metal ion species from the mixture of metals can occur when the one or more metals comes into contact with water in the solvent, thereby dissolving the one or more metal ion species into the solvent. The metal ion species can be selectively dissolved based on the reactivity of the metal ion species with the water in the solvent. The metal ion species that are more reactive with water will dissolve before the metal ion species that are less reactive with water. Upon contact of the metal with a water molecule, the metal is oxidized, and the water decomposes into H_{2(g)} which can be removed from the solvent, and oxide (O²) which can be converted into O_{2(g)} and removed from the solvent.

For example, selectively dissolving one or more metal ion species from the mixture of metals can include both changing the electrical potential applied to the cathode and controlling the residual water content in the solvent.

In methods of the disclosure, an electrical potential is applied to the reducing electrode while the metal ion species are selectively dissolved in the solvent. The electrical potential of the reducing electrode is selected such that the metal ion species can be reduced and deposited, thereby separating the metal or mixture of metals from the mixture of metal oxides. For example, the electrical potential applied to the reducing electrode can be 0 V to 5 V, or 0 V to 3 V.

### EXAMPLES

The following examples are provided for illustration and are not intended to limit the scope of the invention.

### Methods

SEM-EDS micrographs and X-ray element maps were taken using a Hitachi S-3400N scanning electron microscopy (SEM) with an associated backscattered electron (BSE) detector and energy-dispersive X-ray emission spectrometer (EDS; Bruker). SEM micrographs were taken using a Hitachi S-3400N scanning electron microscopy (SEM) with an associated backscattered electron (BSE) detector. Cyclic voltammograms were collected using a Gamry Interface 5000 potentiostat with a W wire electrode.

### Example 1—Reduction of Metal Oxide and Mixed Metal Oxide Under Inert Gas

Initial tests were performed in a molten hydroxide solvent that was prepared in a glove box before the test was started. Hydroxide salts, metal oxides, and mixed metal oxides were obtained from commercial sources. Tests were performed using a stainless-steel cathode basket containing metal oxide or mixed metal oxide, which was sealed within a stainless-steel test vessel. The cathode basket was subjected to reducing conditions. After reduction, the cell was cooled down and the reduction product was removed, washed, and filtered to remove entrained salt. A photograph showing a typical commercial NMC reagent and product is shown in FIG. 2.

### Reduction of Metal Oxide Under Inert Gas

The reduction of neodymium oxide (Nd₂O₃) was evaluated by the procedure described above, with a eutectic mixture of NaOH and KOH as solvent at 180° C. The product was isolated and characterized by scanning electron microscopy with energy-dispersive X-ray spectroscopy (SEM-EDS) to measure the chemical make-up of the recovered product shown in FIG. 3. The oxygen depleted regions indicated that the reduction of neodymium oxide was successful.

### Reduction of Mixed Metal Oxide Under Inert Gas

The reduction of different lithium nickel manganese cobalt oxides (NMCs), namely NMC 111 and NMC 622, were evaluated by the procedure described above, with a eutectic mixture of LiOH and KOH as solvent at 280° C.

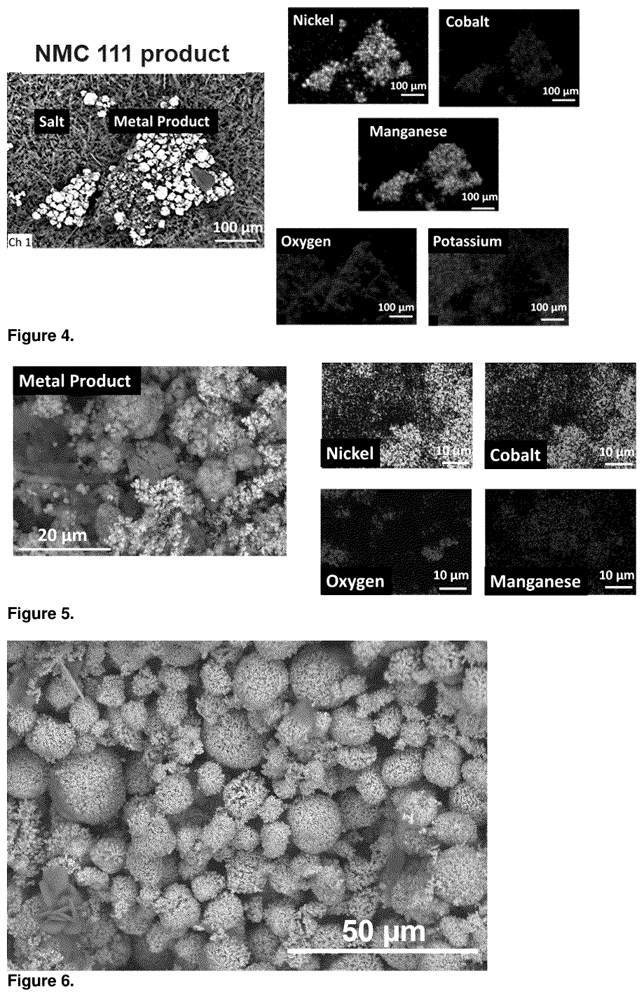

After reduction, each of the reduced metal NMC products was gray and had the same powder morphology as the NMC reagent prior to reduction. However, some material became soluble and accumulated in the molten salt. The reduced metal NMC product was recovered and examined by SEM-EDS to measure the chemical make-up of the recovered product for NMC 111 and NMC 622, as shown in FIGS. 4 and 5, respectively. The recovered product had distinguishable, incompletely reduced phases with detectable oxygen contents that were distributed in the reduced Ni-Mn—Co alloy phases.

### Example 2—Reduction and Electrowinning of Mixed Metal Oxide in Air

Additional tests were performed using reagents prepared in air instead of an inert atmosphere. Tests were performed with NMC 622 using the same reducing conditions, with a eutectic mixture of LiOH and KOH at 280° C. as solvent. The solvent turned blue after reduction. The reduced material recovered from the cathode basket was analyzed by SEM-EDS, shown in FIG. 6. The recovered product contained 70 at % Ni, 18.2 at % Co, 0.5 at % Mn, and 11.3 at % O by averaging the composition over the entire image. This indicated that the product was partially reduced.

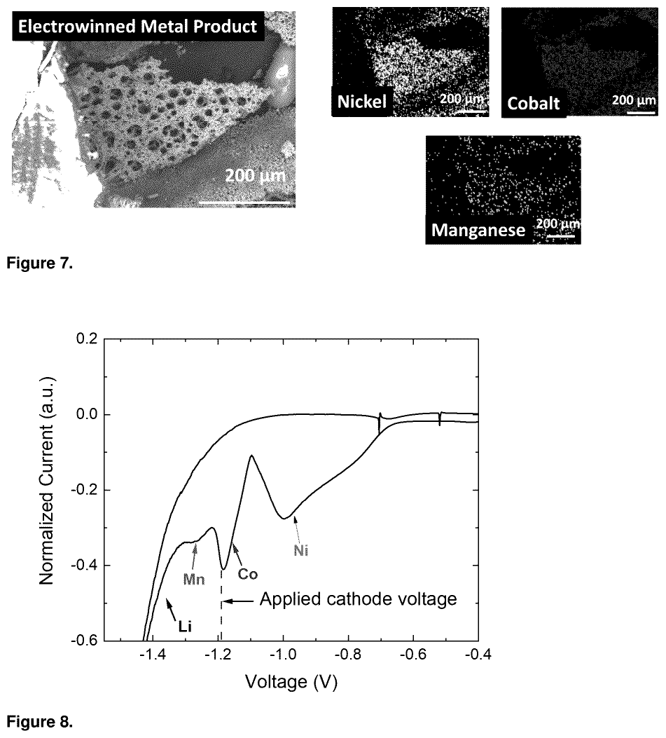

The blue solvent was reheated and electrolyzed onto another electrode to characterize the dissolved species. The cathode was subjected to the same electrolysis conditions used in the air-prepared tests. After the blue solvent was electrowinned at a constant voltage of 1.1 V, the deposited product was rinsed, filtered, and analyzed by SEM-EDS, shown in FIG. 7. The product was found to be 44 at % Ni, 55.5 at % Co, and 0.5 at % Mn. The coulombic efficiency of the overall process was 40%.

The electrochemical properties of the blue solvent were further evaluated by cyclic voltammetry. A cyclic voltammogram (CV) of the blue solvent is shown in FIG. 8. The cyclic voltammogram showed peaks associated with the reduction of the metal components of NMC 622. These peaks represented the reduction of the constituent metal ions of Ni, Co, Mn, and Li, listed in order of increasing negative reduction potentials. The applied cathode voltage was close to the reduction potential for cobalt, which was more negative than the reduction potential for nickel, and less negative than the reduction potentials for manganese or lithium.

### Example 3—Drying Molten Salt Solution

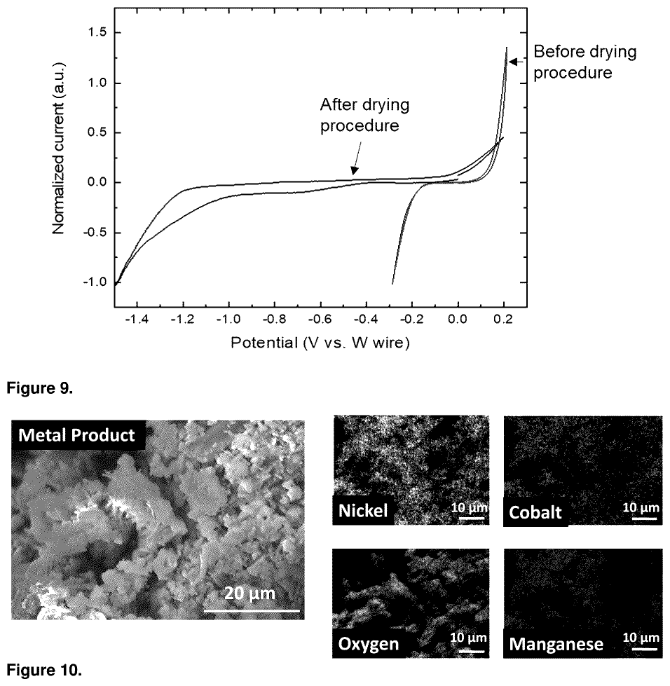

It was observed that the cathode voltage during reduction was 0.35 V, which indicated that water decomposition is a parasitic reaction during reduction. Two drying procedures were tested and demonstrated to be effective: electrolytic drying and vacuum drying. Electrolytic drying was performed by electrolyzing the water in the molten salt to hydrogen and oxygen gas, which are vented out of the test vessel by an argon gas purge. Vacuum drying was performed by placing the molten salt under a vacuum to volatilize the dissolved water. FIG. 9 shows a cyclic voltammogram on tungsten in the LiOH—KOH eutectic melt before and after the vacuum drying procedure. The electrochemical window increased by about 1 V after the salt was dried.

### Example 4—Reduction of Mixed Metal Oxide with Dried Molten Salt

Electrochemical conversion of NMC 622 to a metal alloy was tested in the dry molten salts by using constant potential electrolysis at 1.3 V. FIG. 10 shows an SEM micrograph with EDS mapping of the metal product that was recovered from the surface of the current collector.

Battery material that was not directly in contact with the current collector was not converted to metal, leading to low overall coulombic efficiency. The conductivity of NMC powder was low, indicating adequate electronic conductivity between the NMC and current collector was required. Previous tests in hydrated salts showed higher coulombic efficiency than dry salts (40%) because electrolytically-generated hydrogen from the decomposition of water impurities aided in the reduction of the oxides to metal alloys.

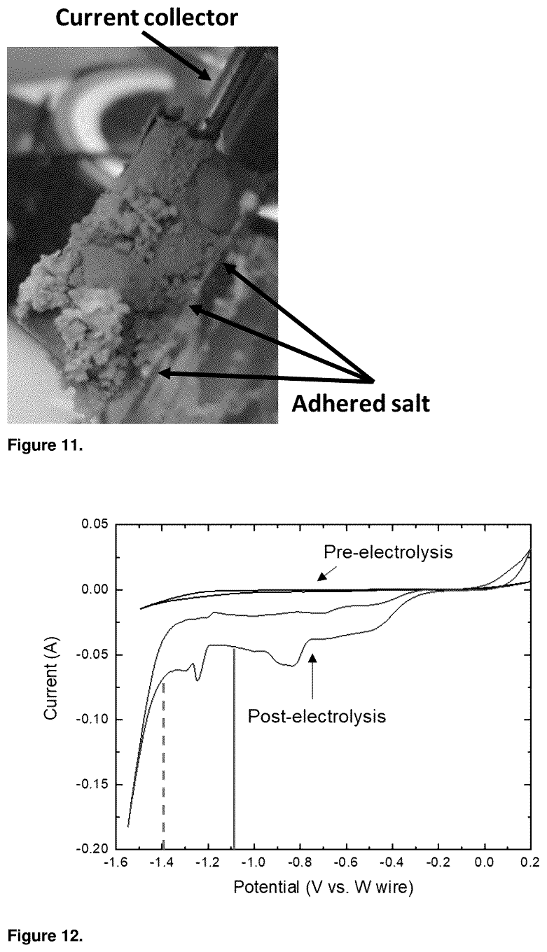

Visual observation of the salt after reduction showed a blue-green color change, indicating that cathode material had dissolved into the melt during the reduction. A picture of cathode with salt adhered, containing the dissolved cathode material is shown in FIG. 11. A CV performed on a tungsten wire after NMC reduction (FIG. 12) showed several peaks that were not present in measurements with the dry salt before reduction.

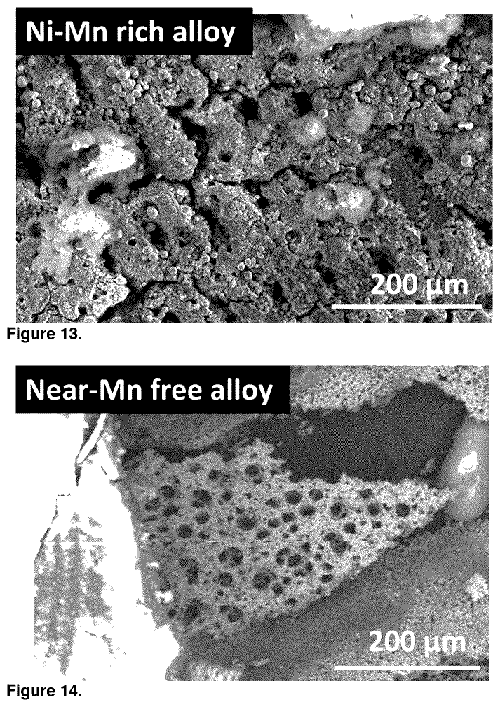

Electrowinning was similarly performed in molten hydroxide salts with the dissolved cathode material from the dry-salt tests to confirm recovery of dissolved cathode material. The applied voltage of the reducing electrode was held constant at 1.4 V (FIG. 12, solid line) and the material deposited was identified as a Ni-Mn rich alloy by SEM (FIG. 13). This contrasts with the electrowinning performed in Example 2 where the applied voltage of the reducing electrode was held constant at 1.1 V (FIG. 12, dashed line) and the material deposited was identified as a Ni-Co rich alloy by SEM (FIG. 14).

The foregoing description is given for clearness of understanding only, and no unnecessary limitations should be understood therefrom, as modifications within the scope of the disclosure may be apparent to those having ordinary skill in the art.

All patents, patent applications, government publications, government regulations, and literature references cited in this specification are hereby incorporated herein by reference in their entirety. In the case of conflict, the present description, including definitions, will control.

Throughout the specification, where the compounds, compositions, methods, and/or processes are described as including components, steps, or materials, it is contemplated that the compounds, compositions, methods, and/or processes can also comprise, consist essentially of, or consist of any combination of the recited components or materials, unless described otherwise. Component concentrations can be expressed in terms of weight concentrations, unless specifically indicated otherwise. Combinations of components are contemplated to include homogeneous and/or heterogeneous mixtures, as would be understood by a person of ordinary skill in the art in view of the foregoing disclosure.

What is claimed is:

1. A method of extracting and separating metals from a mixture of metal oxides comprising:
disposing a cathode comprising the mixture of metal oxides, a reducing electrode, and an anode in a solvent comprising a mixture of molten metal hydroxide salts;
applying an electrical potential to a cathode, thereby reducing the mixture of metal oxides and forming a mixture of metals;
selectively dissolving one or more metal ion species from the mixture of metals into the solvent; and
applying a potential to the reducing electrode present in the solvent to reduce the dissolved metal ion species from the solvent to a respective pure metal or mixed metal; wherein:
selectively dissolving one or more metal ion species from the mixture of metals comprises:
i) increasing or decreasing the electrical potential applied to the cathode, or
ii) controlling a water content of the solvent such that upon contact of the one or more metals with the water of the solvent, selective ones of the one or more metals oxidize and thereby the selective ones of the one or more metal ion species are dissolved into the solvent.

2. The method of claim 1, further comprising drying the solvent before disposing the cathode, the reducing electrode, and the anode in the solvent.

3. The method of claim 2, wherein the solvent is dried by i) reducing the pressure of the solvent, thereby evaporating water present in the solvent, or ii) passing an electrical current through the solvent, thereby electrolyzing water present in the solvent.

4. The method of claim 3, wherein the pressure of the solvent is reduced to a pressure of 2500 Pa or less.

5. The method of claim 3, wherein the pressure in the reaction chamber is reduced for a time of 30 minutes to 720 minutes.

6. The method of claim 5, further comprising purging the solvent with an inert gas selected from Ar_{(g)}, N_{2(g)}, and He_{(g)} after drying the solvent.

7. The method of claim 3, wherein the electrical current is 0.01 A to 5 A and/or the electrical current is passed through the solvent for 30 minutes to 360 minutes.

8. The method of claim 1, wherein the solvent is dried to a water content below 5% (w/w).

9. The method of claim 1, wherein the solvent comprises at least one alkali metal hydroxide salt selected from LiOH, NaOH, and KOH and/or at least one alkaline earth metal hydroxide salt selected from Mg(OH)₂ and Ca(OH)₂.

10. The method of claim 1, wherein the solvent is a mixture of LiOH and KOH or NaOH and KOH.

11. The method of claim 1, wherein the solvent is a eutectic mixture.

12. The method of claim 1, wherein the reducing electrode and the anode each independently comprise one or more element selected from C, Fe, Ni, W, Mo, Ta, Ti, V, Cr, Mn, Zr, and Hf.

13. The method of claim 1, wherein the mixture of metal oxides comprises one or more alkali metal oxides, alkaline earth metal oxides, transition metal oxides, and rare earth metal oxides.

14. The method of claim 13, wherein the mixture of metal oxides comprises transition metal oxides and alkali metal oxides.

15. The method of claim 1, wherein the electrical potential applied to the cathode is 0 V to 5 V and/or the electrical potential applied to the reducing electrode is 0 V to 5 V.

16. The method of claim 1, wherein selectively dissolving one or more metal ion species from the mixture of metals comprises increasing or decreasing the electrical potential applied to the cathode.

17. The method of claim 16, wherein the electrical potential applied to the cathode is increased or decreased by an amount of 0.005 V/s to 5 V/s.

18. The method of claim 1, wherein selectively dissolving one or more metal ion species from the mixture of metals comprises controlling the water content of the solvent such that upon contact of the one or more metals with the water of the solvent, selective ones of the one or more metals oxidize and thereby selective ones of the one or more metal ion species are dissolved into the solvent.

19. The method of claim 1, wherein the pure metal or mixed metal has a purity of 70% to 99% (w/w).

20. The method of claim 1, wherein the solvent is dried at a temperature of 150° C. to 1000° C.
